(19) United States
(12) Patent Application Publication
(10) Pub. No.: US 2007/0020556 A1
(43) Pub. Date: Jan. 25, 2007

(54) PHOTOSENSITIVE ARTICLES AND RELATED MANUFACTURING PROCESS

(75) Inventor: Sandra R. Danon, Chatsworth, CA (US)

Correspondence Address: KELLY LOWRY & KELLEY, LLP, 6320 CANOGA AVENUE, SUITE 1650, WOODLAND HILLS, CA, 91367, US

(73) Assignee: STRAVINA OPERATING COMPANY, LLC, Chatsworth, CA (US)

(21) Appl. No.: 11/161,145

(22) Filed: Jul. 25, 2005

(51) Int. Cl. G03C 1/00

(52) U.S. Cl. 430/270.1

(57) ABSTRACT

A decorative photosensitive article having a design formed of a plurality of polyvinyl chloride plasticizers. At least one of the polyvinyl chloride plasticizers includes a photochromic pigment such that when exposed to light, the polyvinyl chloride plasticizer portion of the design having the photochromic pigment changes color, whereas the other portions of the design change to different colors or remain the same to create a desired visual appearance.

### BACKGROUND OF THE INVENTION

The present invention generally relates to articles and novelty items comprised of plastic, such as polyvinyl chloride and the like. More particularly, the present invention relates to articles and novelty items having a entirely formed of polyvinyl chloride such that a photo pigment added to at least a portion of the design changes color upon exposure to light, creating a desired visual appearance.

Articles and manufactured objects which change colors are known. Sometimes, such designs are intended to serve a particular purpose. For example, U.S. Pat. No. 6,719,210 discloses a sprayer comprised of a material having a thermochromic pigment such that as the fluid level in the sprayer is lowered, the portion of the sprayer containing the fluid is one color, while the gaseous portion above the liquid is another color. The color changes are brought about by the subtle changes of temperature between the gas above and the liquid below. In this manner, the user of the sprayer device can readily determine the level of the liquid.

In other instances, the change is purely aesthetic. For example, in many children's bottles and sipping cups, the same effect is achieved when cold milk or juice is added thereto. However, the effect is merely intended to be interesting and aesthetically pleasing to the parent or child.

There exist toys and other objects which include illuminescent material, such that when the object is removed from the light into a darker area, the florescent or luminescent pigment emits light therefrom. However, such effect is only noticeable when the object is in the dark. Otherwise, when the object is in sunlight or room light, there is no appearance of light given off by the object.

Accordingly, there is a continuing need for articles, such as novelty items and the like, designed such so that exposure to the light creates a color change in selected portions of the design of the article to create a desired visual effect. The present invention fulfills this need and provides other related advantages.

### SUMMARY OF THE INVENTION

The present invention resides in a decorative photosensitive article, and the method for making the same. The photosensitive articles embodying the present invention generally comprise a base, which may be flexible. A first polyvinyl chloride plasticizer having a first photochromic pigment is fixed to the base. A second polyvinyl chloride plasticizer is also fixed to the base. Preferably, the first and second polyvinyl chloride plasticizers cooperatively form a three-dimensional design on the base or article. The article may comprise one of a key chain, a magnet, jewelry, a wristband, a photograph frame, or any other such novelty item which may include a three-dimensional design thereon.

The effect of the present invention is that upon exposure to light, the first polyvinyl chloride plasticizer changes color, and the second polyvinyl chloride plasticizer either changes to a different color or remains the same color to create a desired visual appearance. In the case when the second polyvinyl chloride plasticizer changes color, it includes a second photochromic pigment.

The method for making such an article, in accordance with the present invention, generally comprises the steps of providing a first polyvinyl chloride plasticizer having a first photochromic pigment added thereto. A second polyvinyl chloride plasticizer is also provided, which may or may not have a second photochromic pigment as discussed above. A third, or additional polyvinyl chloride plasticizers may be provided having different photochromic pigments added thereto.

A design for an article is created, which is preferably a three-dimensional design. At least a portion of the design is comprised of the first polyvinyl chloride plasticizer, a second portion of the design comprises the second polyvinyl chloride plasticizer, etc. Upon exposure to light, the first portion of the design comprised of the first polyvinyl chloride plasticizer with the first photochromic pigment changes color. Additional portions of the design having polyvinyl vinyl chloride plasticizers with different photochromic pigments also change color, preferably a different color. Any portions of the design comprised of polyvinyl chloride plasticizer without any photochromic pigment added thereto remains the same color. The end result is the creation of a desired visual appearance which is different from that of the design before exposed to the light.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a photosensitive article embodying the present invention;

FIG. 2 is a top view of the article of FIG. 1;

FIG. 3 is a top view of the article, illustrating by shaded lines different portions of the design thereof representing different colors in a non-illuminated state;

FIG. 4 is a top view of the article of FIG. 3, illustrating the color changes when illuminated with light;

FIG. 5 is a cross-sectional view taken generally along line 5-5 of FIG. 3; and

FIG. 6 is cross-sectional view taken generally along line 6-6 of FIG. 4, and illustrating the change in color of different portions of the design and article due to exposure to light.

### DETAILED DESCRIPTION OF THE PREFERRED EMBODIMENTS

As shown in the accompanying drawings, for purposes of illustration, the present invention resides in a photosensitive article, and a method for making such an article. In particular, the present invention is directed to an article, or a design on an article, which is comprised of a plurality of polyvinyl chloride plasticizers. As will be more fully discussed herein, the design or article is comprised such so as to change visual affects in the presence of light and in the absence of light.

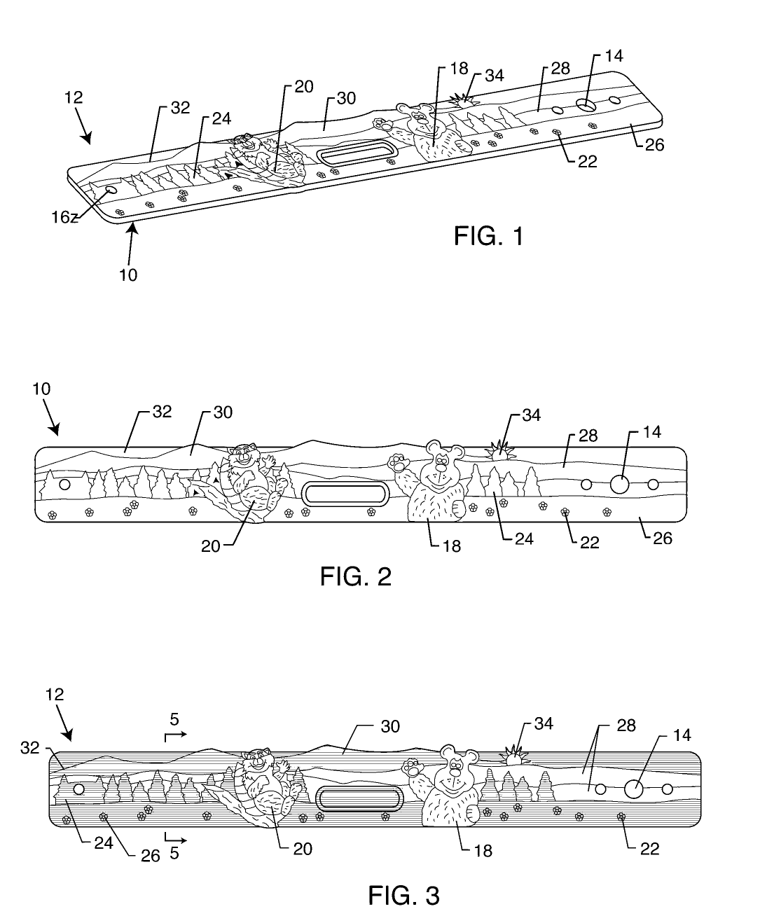

With reference now to FIGS. 1 and 2, a photosensitive article 10 is illustrated having a design 12 formed as a part thereof or thereon. For exemplary purposes, the article 10 which is illustrated and described herein is a wristband or the like which is generally rectangular and elongated, and includes a plurality of apertures 14 through which a projection 16 can be snap-fit, so as to be worn about an individual's wrist. Of course, other closure means can be implemented such as hook and loop tape, clasps and the like. The wristband article 10 can also support other items such as watches, etc. It will be appreciated that the invention is not necessary limited to a wristband, but can be implemented into other articles such as key chains, magnets, picture frames, etc.

The design 12 formed as part of the article 10, or on the article, is preferably a three-dimensional design. As shown in FIGS. 1 and 2, the exemplary designed illustrated herein includes animal caricatures in the form of a bear 18, a racoon 20, small flowers 22, trees 24, a grassy plain or lake 26, rolling hills 28, a mountain range 30, a sky 32, and a sun 34. Each of these items 18-34 are considered portions of the design, or as will be described more fully herein certain groupings of these elements 18-34 of these design elements 18-34 are portions of the design.

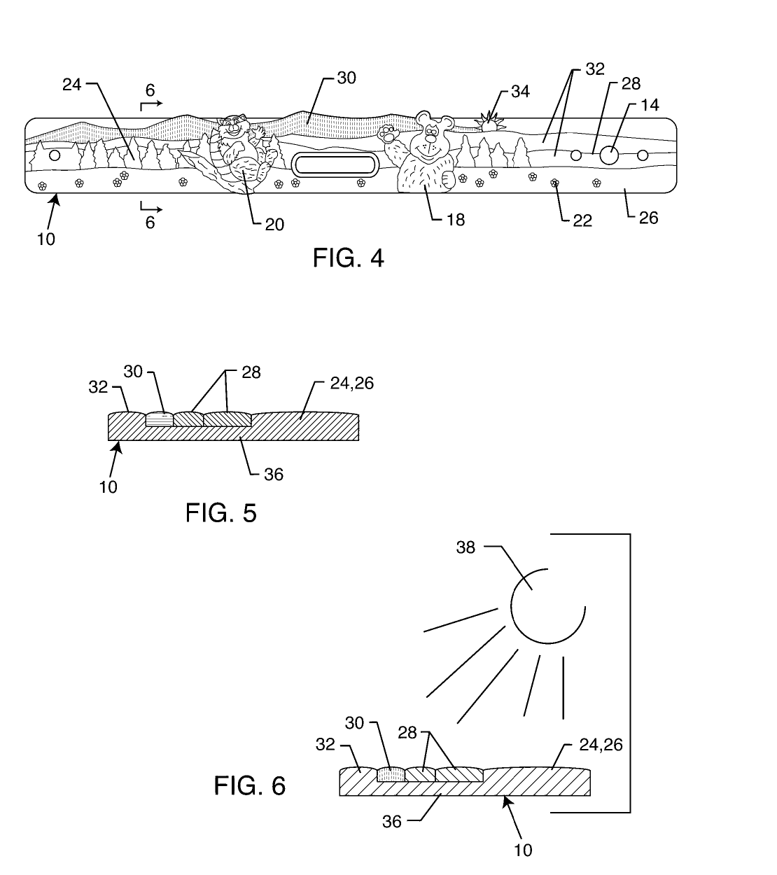

With reference now to FIGS. 3-6, FIGS. 3 and 5 illustrate the visual appearance of article 10 when the article 10 is not subjected to a light source, such as the sun. In the exemplary article 10, the design elements of the bear 18, racoon 20, flowers 22, rolling hills 28 and sun 34, are comprised of a polyvinyl chloride plasticizer material which has a non-photochromic pigment. Thus, the coloration and pigment of these elements are constant. For example, the bear element 18 could be pigmented brown, while the rolling hills 28 could be pigmented a light green, while the sun element 30 is orange or yellow. In fact, the rolling hills 28 could be of a different pigment green to provide visual interest. However, the mountain range portion 30 of the design 12 is comprised of another polyvinyl chloride plasticizer having a photochromic pigment added thereto, represented by the shaded lines in FIG. 4. The tree elements 24, lake or grassy plain element 26 and sky 32 in the illustrated embodiment are all comprised of the same polyvinyl chloride plasticizer having yet a different photochromic pigment added thereto, as shown by the common shading of these elements 24, 26 and 32.

With reference now to FIG. 5, when making such an article 10, a plurality of polyvinyl chloride plasticizers are provided. In the case of the illustrated design, a first polyvinyl chloride plasticizer having a first photochromic pigment is used to create the lake or field design elements 24 and 26, an underlying base 36, which is preferably flexible, and the sky 32. This is done by adding approximately 5% total weight of the selected photochromic pigment to the first polyvinyl chloride plasticizer material.

This first polyvinyl chloride plasticizer with the first photochromic pigment is then typically injection molded to form the design elements 24, 26 and 32 as well as the base 36. In this case, the wristband article 10 is completely comprised of the polyvinyl chloride plasticizer material. In other instances, such as magnets or picture frames, the base may be the underlying picture frame, magnet, or a rigid base with the polyvinyl chloride plasticizer design adhered thereto or otherwise formed thereon during the manufacturing process.

With continuing reference to FIG. 5, the rolling hills element 28 is comprised of a second polyvinyl chloride plasticizer, which may have a pigment, but in this case is not a photochromic pigment. The second polyvinyl chloride plasticizer is injection molded onto the base 36, in such a manner so as to create the intended three-dimensional design.

Next, the mountain range portion 30 of the design 12 is injection molded as determined by the design 12. In this case, the mountain 30 is comprised of a third polyvinyl chloride plasticizer having a second photochromic pigment, which is different than the photochromic pigment of elements 24, 26 and 32. It will be appreciated that it is contemplated by the present invention that only a single portion of the design 12 be comprised of a polyvinyl chloride plasticizer material having a photochromic pigment added thereto with one or more other portions formed of a non-photochromic pigment of polyvinyl chloride plasticizer, or that several different portions, or even all portions, of the design be comprised of polyvinyl chloride plasticizers having different photochromic pigments. The end result is to create a desired visual appearance which changes upon exposure to light.

With reference now to FIGS. 4 and 6, when exposed a light source, such as sunlight 38, those portions of the design 12 which do not have any photochromic pigment, such as the rolling hills 28, sun 34, bear 18, racoon 20, etc., remain the same color as in the original design. However, those portions of the design 12 which include photochromic pigment change color. As illustrated, the portion of the design or article element having the lake or field element 26, tree elements 24 and sky element 32 all change to a different color. This is based upon the selection of the photochromic pigment and so can be controlled. However, the portion of the design, represented by the mountain range element 30 changes to yet a different color, as illustrated by the shading in FIGS. 4 and 6.

When the article 10 or design 12 is removed from the source of light, the portions of the design 12 comprised of the polyvinyl chloride plasticizers having photochromic pigments change back to their original color, as illustrated in FIG. 3. Of course, those portions of the design 12 which do not have any photochromic pigment remain the same color regardless of light exposure.

Although several embodiments have been described in detail for purposes of illustration, various modifications may be made to each without departing from the scope and spirit of the invention. Accordingly, the invention is not to be limited, except as by the appended claims.

What is claimed is:

1. A method for making an article, comprising the steps of:
providing a first polyvinyl chloride plasticizer;
adding a photochromic pigment to the first polyvinyl chloride plasticizer;
providing a second polyvinyl chloride plasticizer; and
creating a design for an article, at least a first portion of which comprises the first polyvinyl chloride plasticizer with the photochromic pigment and a second portion of which comprises the second polyvinyl chloride plasticizer;
wherein upon exposure to light, the first portion of the design comprised of the first polyvinyl chloride plasticizer with the photochromic pigment changes color and the second portion comprised of the second polyvinyl chloride plasticizer remains the same color to create a desired visual appearance.

2. The method of claim 1, wherein the creating the design step comprises creating a three-dimensional design.

3. The method of claim 1, wherein the article comprises one of a key chain, a magnet, jewelry, a wristband, and a photograph frame.

4. The method of claim 1, including the step of providing a third polyvinyl chloride plasticizer, and adding a second photochromic pigment, and wherein the creating the design step includes the step of forming a portion of the design with the third polyvinyl chloride plasticizer having the second photochromic pigment such that when the design is exposed to light, the first polyvinyl chloride plasticizer with the photochromic pigment changes color, the third polyvinyl chloride plasticizer having the second photochromic pigment changes to a different color, and the portion comprised of the second polyvinyl chloride plasticizer remains the same color.

5. A method for making an article, comprising the steps of:
providing a first polyvinyl chloride plasticizer;
adding a first photochromic pigment to the first polyvinyl chloride plasticizer;
providing a second polyvinyl chloride plasticizer;
adding a second photochromic pigment to the second polyvinyl chloride plasticizer;
creating a design for an article, at least a first portion of which comprises the first polyvinyl chloride plasticizer with the first photochromic pigment and a second portion of which comprises the second polyvinyl chloride plasticizer with the second photochromic pigment;
wherein upon exposure to light, the first portion of the design comprised of the first polyvinyl chloride plasticizer with the photochromic pigment changes color and the second portion comprised of the second polyvinyl chloride plasticizer changes to a different color to create a desired visual appearance.

6. The method of claim 5, wherein the creating the design step comprises creating a three-dimensional design.

7. The method of claim 5, wherein the article comprises one of a key chain, a magnet, jewelry, a wristband, and a photograph frame.

8. The method of claim 5, including the step of providing a third polyvinyl chloride plasticizer, and wherein the creating the design step includes the step of forming a third portion of the design with the third polyvinyl chloride plasticizer such that when the design is exposed to light, the first polyvinyl chloride plasticizer with the first photochromic pigment changes color, the second polyvinyl chloride plasticizer having the second photochromic pigment changes to a different color, and the portion comprised of the third polyvinyl chloride plasticizer remains the same color.

9. A decorative photosensitive article, comprising:
a base;
a first polyvinyl chloride plasticizer, having a first photochromic pigment, fixed to the base; and
a second polyvinyl chloride plasticizer fixed to the base;
wherein upon exposure to light, the first polyvinyl chloride plasticizer changes color and the second polyvinyl chloride plasticizer changes to a different color or remains the same color to create a desired visual appearance.

10. The article of claim 9, wherein when the second polyvinyl chloride plasticizer changes color, it includes a second photochromic pigment.

11. The article of claim 9, wherein the article comprises one of a key chain, a magnet, jewelry, a wristband, and a photograph frame.

12. The article of claim 9, wherein the base is flexible.

13. The article of claim 9, wherein the first and second polyvinyl chloride plasticizers cooperatively form a three-dimensional design.
